(19) United States
(12) Patent Application Publication
(10) Pub. No.: US 2016/0086622 A1
(43) Pub. Date: Mar. 24, 2016

(54) SPEECH PROCESSING DEVICE, SPEECH PROCESSING METHOD, AND COMPUTER PROGRAM PRODUCT

(71) Applicant: KABUSHIKI KAISHA TOSHIBA, Tokyo (JP)

(72) Inventor: Masahiro YAMAMOTO, Kawasaki (JP)

(21) Appl. No.: 14/845,310

(22) Filed: Sep. 4, 2015

(30) Foreign Application Priority Data
Sep. 18, 2014 (JP) 2014-190196

(51) Int. Cl. G10L 25/63; G10L 21/10; G10L 25/03

(52) U.S. Cl. CPC G10L 25/63; G10L 25/03; G10L 21/10

(57) ABSTRACT

According to an embodiment, a speech processing device includes an analyzer, a feature quantity calculator, a comparator, and a sensation index calculator. The analyzer performs multiple pseudo frequency analyses each using different window functions on subject speech to be processed. The feature quantity calculator calculates a feature quantity of the subject speech on the basis of analysis results of the multiple pseudo frequency analyses. The comparator compares the feature quantity of the subject speech with a reference feature quantity calculated from reference speech and generates a comparison result. The sensation index calculator calculates a sensation index representing a sensation received from the subject speech on the basis of the comparison result.

### CROSS-REFERENCE TO RELATED APPLICATION(S)

This application is based upon and claims the benefit of priority from Japanese Patent Application No. 2014-190196, filed on Sep. 18, 2014; the entire contents of which are incorporated herein by reference.

### FIELD

Embodiments described herein relate generally to a speech processing device, a speech processing method, and a computer program product.

### BACKGROUND

Evaluation of speech is very important in dialog and communication. In particular, in building a dialog system, objective evaluation of naturalness in dialog forms the basis in the process of smooth dialog and communication. There have thus been various proposals for evaluation of naturalness with a focus on the quality of speech.

An evaluation method focusing on the speech quality, however, can evaluate the naturalness of fragments of sound but cannot evaluate the influence of speech on human sensations. There is also a method of evaluating speech as continuous sound from a spectral envelope. With this method, however, some features may be missing because secondary feature quantities are generated from a spectral envelope, and it is thus difficult to appropriately evaluate the influence of speech on human sensations. There have therefore been demands for a proposal for a new technology capable of appropriately evaluating what influence speech has on human sensations.

An object to be achieved by the present invention is to provide a speech processing device, a speech processing method, and a program therefor capable of appropriately evaluating what influence speech has on human sensations.

### BRIEF DESCRIPTION OF THE DRAWINGS

FIG. 1 is a block diagram illustrating an example configuration of a speech processing device according to a first embodiment;

FIG. 2 is a diagram illustrating an example of a message displayed on a display;

FIG. 3 is a graph illustrating an example of window functions;

FIG. 4 is a diagram illustrating an example of window functions classified into sensation categories;

FIG. 5 illustrates an example of sensation indices;

FIG. 6 is a graph illustrating an example of processing for comparing feature quantities of subject speech with reference feature quantities;

FIG. 7 is a flowchart illustrating an outline of operation of the speech processing device according to the first embodiment;

FIG. 8 is a block diagram illustrating an example configuration of a speech processing device according to a second embodiment;

FIG. 9 is a block diagram illustrating an example configuration of a speech processing device according to a third embodiment; and

FIG. 10 is a block diagram illustrating an example hardware configuration of the speech processing device according to the third embodiment.

### DETAILED DESCRIPTION

According to an embodiment, a speech processing device includes an analyzer, a feature quantity calculator, a comparator, and a sensation index calculator. The analyzer performs multiple pseudo frequency analyses each using different window functions on subject speech to be processed. The feature quantity calculator calculates a feature quantity of the subject speech on the basis of analysis results of the multiple pseudo frequency analyses. The comparator compares the feature quantity of the subject speech with a reference feature quantity calculated from reference speech and generates a comparison result. The sensation index calculator calculates a sensation index representing a sensation received from the subject speech on the basis of the comparison result.

### First Embodiment

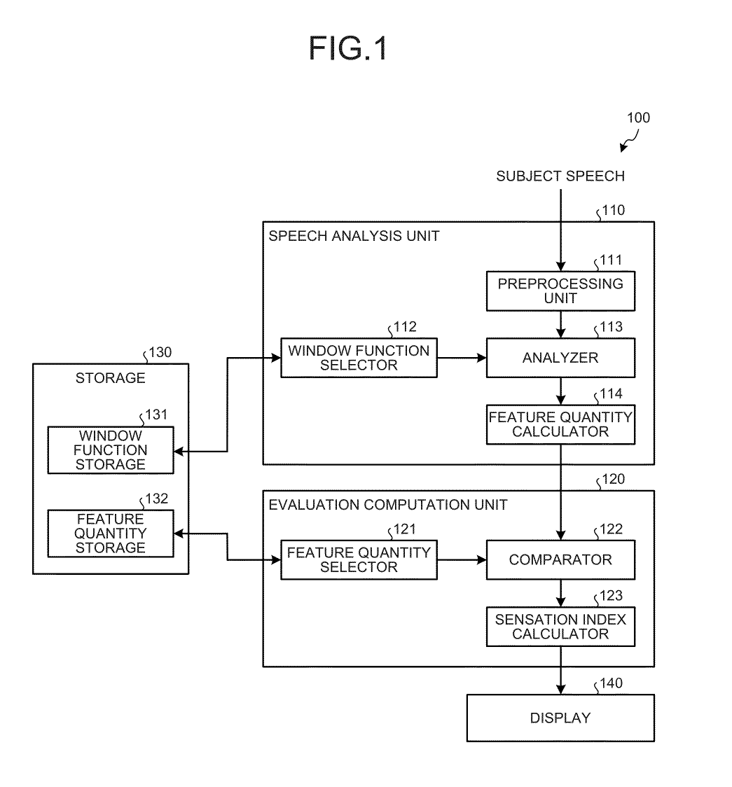

FIG. 1 is a block diagram illustrating an example configuration of a speech processing device 100 according to a first embodiment. As illustrated in FIG. 1, the speech processing device 100 includes a speech analyzer 110, an evaluation computation unit 120, a storage 130, and a display 140. The storage 130 includes a window function storage 131 for storing window functions, which will be described later, and a feature quantity storage 132 for storing reference feature quantities, which will be described later. The display 140 has a function of a user interface of the speech processing device 100 according to the present embodiment, and is configured to display information such as information indicating a processing result or information being processed, a message to a user, and information for accepting user's operation, and receive user's operation specifying a predetermined operation.

The speech analyzer 110 is a block for analyzing speech and calculating feature quantities, and includes a preprocessing unit 111, a window function selector 112, an analyzer 113, and a feature quantity calculator 114 as illustrated in FIG. 1.

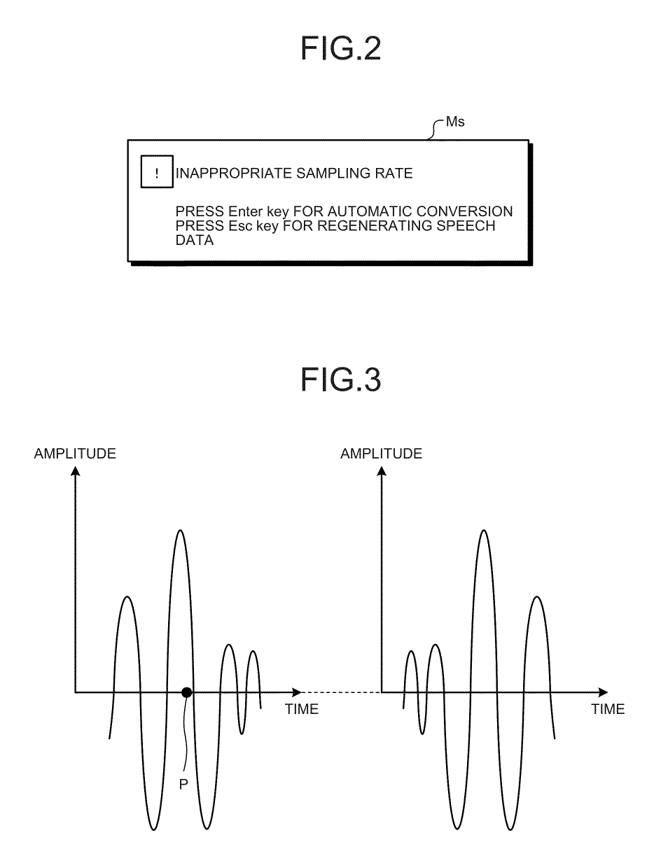

The preprocessing unit 111 performs preprocessing such as receiving speech data of subject speech to be processed from outside and filtering for noise elimination. Note that speech data used in the present embodiment may be speech in natural voice, synthetic speech, or the like generated in any manner. The preprocessing unit 111 also analyzes a sampling rate and data time for speech data of subject speech. In this process, the preprocessing unit 111 compares a sampling rate of speech data of subject speech with sampling rates of reference speeches, which will be described later. If the same sampling rate is not present, the preprocessing unit 111 displays a message Ms as illustrated in FIG. 2, for example, on the display 140 to prompt a user to convert the sampling rate or regenerate speech data. If conversion of the sampling rate is requested by the user, the preprocessing unit 111 converts the sampling rate for the speech data of subject speech. The speech data of subject speech that has been processed by the preprocessing unit 111 is passed on to the analyzer 113.

The window function selector 112 selects a window function to be used for pseudo frequency analysis at the analyzer 113 from the window functions stored in the window function storage 131. The window functions stored in the window function storage 131 are designed as filters for reproducing a sensation received from a speech signal via body parts relating to the sense of hearing and the utterance of human, and examples thereof include adaptive filtering functions and nonlinear filtering functions.

FIG. 3 is a graph illustrating an example of a window function stored in the window function storage 131. As illustrated in FIG. 3, two window functions are stored in a form of a pair in the window function storage 131. In the following, one of the pair will be referred to as a first window function and the other will be referred to as a second window function for the sake of convenience. The first window function is an asymmetric window function along the time axis, and the second window function is a window function obtained by inverting the first window function in the direction of the time axis. Note that an asymmetric window function along the time axis refers to a window function having such a waveform that has the following characteristics: a waveform obtained by turning the waveform 180 degrees about the midpoint (a point P in FIG. 3) on the time axis does not overlap with the original waveform, and the waveform is not symmetric about the line passing through the midpoint on the time axis and being perpendicular to the time axis.

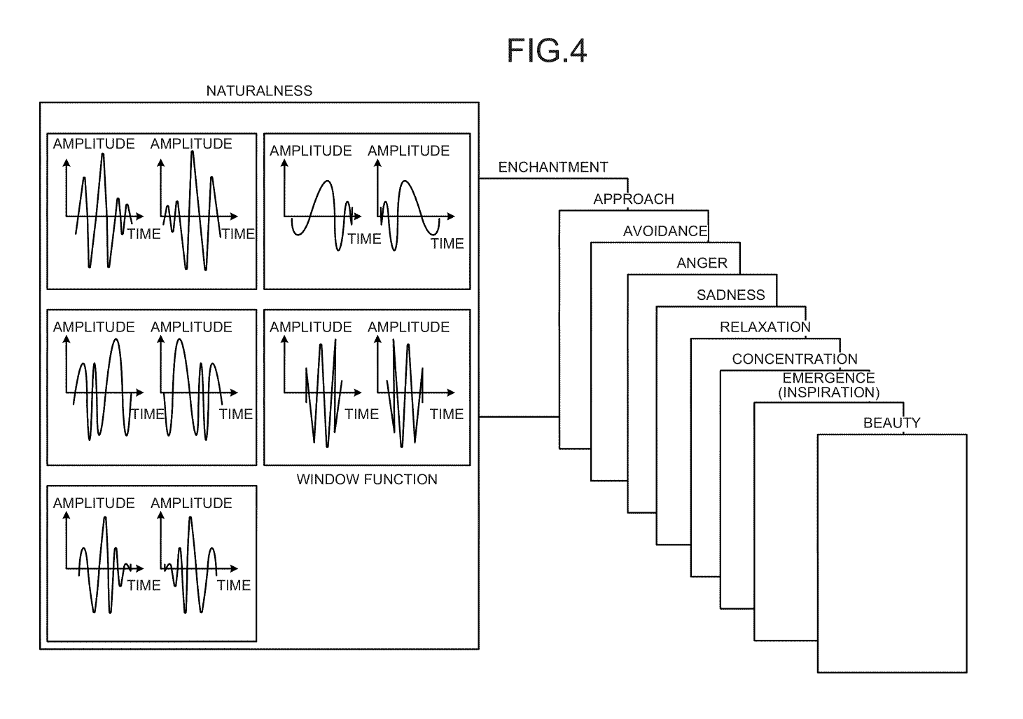

When an operation to register a certain first window function is performed, for example, a second window function obtained by inverting the first window function in the direction of the time axis is automatically generated in response to the operation to register the first window function, and the pair of the first window function and the second window function is stored in the window function storage 131. In this process, the pair of the first window function and the second window function (a pair of window functions) is classified into a sensation category, which is an element of a sensation index, which will be described later, as illustrated in FIG. 4 and stored in the window function storage 131. Sensation categories are based on sensations received from speech.

In the present embodiment, ten sensation categories, which are “naturalness,” “enchantment,” “approach,” “avoidance,” “anger,” “sadness,” “relaxation,” “concentration,” “emergence (inspiration),” and “beauty,” are used, for example. Multiple pairs of the first window function and the second window function described above are stored in each of the sensation categories. In the example of FIG. 4, five pairs of window functions are included in each of the sensation categories. Note that five or more pairs of window functions may be stored in each of the sensation categories, or the pairs of window functions may be stored such that the number of pairs of window functions classified into a sensation category is larger than that of pairs of window functions classified into another sensation category owing to weighting of the sensation categories. For example, to increase the weight of the sensation category “naturalness,” dimensional extension may be carried out by increasing the number of pairs of window functions classified into “naturalness.”

The window function selector 112 at least selects a pair of window functions included in a sensation category to be evaluated in response to a user's selecting operation, for example. When a user performs an operation of selecting a window function belonging to a sensation category, for example, the window function (first window function) selected by the user and a window function (second window function) obtained by inverting the window function in the direction of the time axis are selected, and consequently, a pair of window functions is selected. In this process, when a sensation index including multiple elements is calculated as a sensation index, which will be described later, for subject speech to be processed, a pair of window functions is selected from each of the sensation categories. Alternatively, as in the example illustrated in FIG. 4, when multiple pairs (five pairs in the example of FIG. 4) of window functions are stored in one sensation category, all the pairs of window functions belonging to the sensation category to be evaluated may be selected or some of the pairs of window functions may be selected. As the number of pairs of window functions selected from one sensation category is larger, the robustness of evaluation of the sensation category is increased. The window functions selected by the window function selector 112 are passed on to the analyzer 113.

The analyzer 113 performs pseudo frequency analysis using the window functions selected by the window function selector 112 on the speech data of subject speech received from the preprocessing unit 111. Wavelet analysis is widely known as one example of the pseudo frequency analysis. In wavelet analysis, a signal is multiplied by a wavelet function that is a basis function and a pseudo frequency associated with a scale factor of the wavelet function is analyzed. The speech processing device 100 according to the present embodiment can use this wavelet analysis as pseudo frequency analysis performed by the analyzer 113, for example. In this case, the window functions selected by the window function selector 112 are wavelet functions. Note that the analysis technique used by the analyzer 113 is not limited to wavelet analysis but may be any method capable of analyzing a pseudo frequency by using window functions.

The window function selector 112 described above selects at least a pair of window functions (a first window function and a second window function) for a sensation category to be evaluated. Thus, the analyzer 113 performs at least pseudo frequency analysis using the first window function and pseudo frequency analysis using the second window function on the speech data of subject speech. When multiple sensation categories are to be evaluated, pseudo frequency analysis using at least a pair of window functions that is selected is performed on each of the sensation categories. The analysis result of the pseudo frequency analysis performed by the analyzer 113 is passed on to the feature quantity calculator 114.

The feature quantity calculator 114 calculates feature quantities of the subject speech from the analysis result of the pseudo frequency analysis received from the analyzer 113. As described above, the analyzer 113 performs pseudo frequency analysis using at least a pair of window functions (a first window function and a second window function) for each of the sensation categories to be evaluated as described above. The feature quantity calculator 114 calculates feature quantities of the subject speech on the basis of the analysis result of the pseudo frequency analysis using one (first window function) of a pair of window functions and the analysis result of the pseudo frequency analysis using the other (second window function). When multiple sensation categories are to be evaluated, feature quantities for each of the sensation categories are calculated. Furthermore, when multiple pairs of window functions are selected for one sensation category and pseudo frequency analyses using the respective window functions are performed, feature quantities of the number of dimensions corresponding to the selected pairs of window functions are calculated.

The feature quantities of the subject speech can be obtained by a correlation coefficient along a time axis, for example. Note that the feature quantities of the subject speech may be calculated by using any method capable of defining a feature quantity of a signal having a time axis, such as multiple correlation, or correlation resulting from Mel-frequency cepstral coefficient (MFCC) calculation. The feature quantities of the subject speech calculated by the feature quantity calculator 114 are passed on to a comparator 122, which will be described later, of the evaluation computation unit 120.

The evaluation computation unit 120 is a block for calculating sensation indices of subject speech by using feature quantities calculated through processing performed by the speech analyzer 110, and includes a feature quantity selector 121, the comparator 122, and a sensation index calculator 123 as illustrated in FIG. 1.

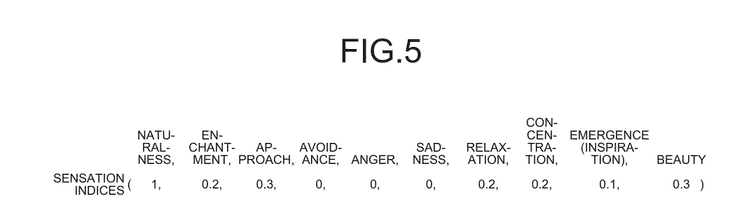

A sensation index is an index expressing a human sensation received from speech, and is a tensor or a vector calculated from the pitch, the band, and the prosody of a signal. For example, a sensation index having the ten sensation categories as described above as elements thereof is expressed by using a ten-dimensional vector corresponding to the respective sensation categories as illustrated in FIG. 5.

The feature quantity selector 121 selects a reference feature quantity to be compared with the feature quantity of the subject speech from the reference feature quantities stored in the feature quantity storage 132 of the storage 130. The reference feature quantities are feature quantities of the respective sensation categories calculated from a large number of reference speeches (reference speech group), and can be calculated by performing the processing in the speech analyzer 110 described above on the large number of reference speeches, for example. The reference speeches are speeches used for generating the reference feature quantities, and are classified into one or more sensation categories on the basis of reference sensation indices, which will be described later. Note that the reference speeches are preferably speeches having standard prosody of male and female. In addition, the reference speeches preferably include natural speeches uttered with emotion by humans. For example, various natural speeches with various emotions are recorded, and reference feature quantities calculated by performing the processing in the speech analyzer 110 described above on speech data of the natural speeches are classified into sensation categories on the basis of the reference sensation indices calculated in advance and are stored in the feature quantity storage 132.

The feature quantity storage 132 has stored therein the reference feature quantities described above in association with the reference speeches and the reference sensation indices used for the calculation of the reference feature quantities. Alternatively, the reference speeches may be input to the speech analyzer 110 described above and also stored in the feature quantity storage 132, and may be associated with the reference feature quantities after the reference feature quantities are calculated by the speech analyzer 110.

The feature quantity selector 121 selects a reference feature quantity associated with a sensation category to be evaluated from the feature quantity storage 132. Specifically, the feature quantity selector 121 selects a reference feature quantity belonging to the same sensation category as the window function used for the pseudo frequency analysis for calculating a feature quantity of the subject speech from the feature quantity storage 132. When multiple sensation categories are to be evaluated and a feature quantity of the subject speech is calculated for each of the sensation categories by the feature quantity calculator 114, the feature quantity selector 121 selects a reference feature quantity for each of the sensation categories. The reference feature quantities selected by the feature quantity selector 121 are passed on to the comparator 122.

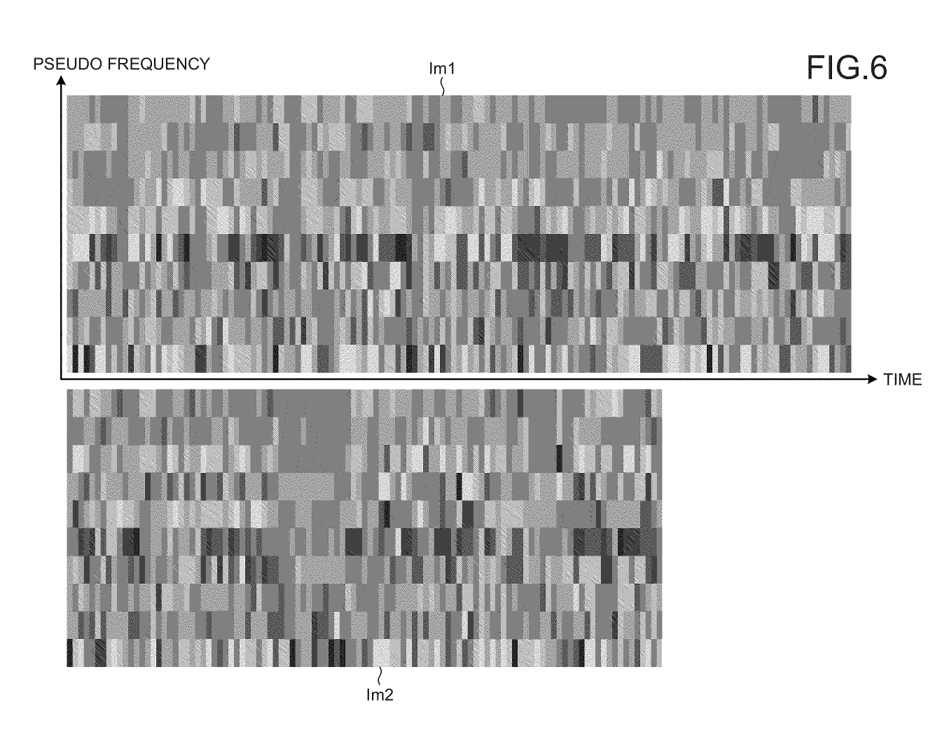

The comparator 122 compares the feature quantities of the subject speech received from the feature quantity calculator 114 of the speech analyzer 110 with the reference feature quantities received from the feature quantity selector 121, and generates a comparison result. For example, for comparison of feature quantities calculated from results of wavelet analyses performed by the analyzer 113, the processing of the comparator 122 can be performed as matching of images as illustrated in FIG. 6, for example.

The example illustrated in FIG. 6 presents comparison of a feature image Im1 representing feature quantities of the subject speech with a feature image Im2 representing reference feature quantities in the sensation category “naturalness.” In the feature images Im1 and Im2 illustrated in FIG. 6, the vertical direction represents the magnitude of pseudo frequency and the horizontal direction represents time. In addition, the density distribution in FIG. 6 represents signal strengths, in which a denser part indicates a higher signal strength. As illustrated in FIG. 6, the feature image Im1 representing the feature quantities of the subject speech can be compared with the feature image Im2 representing the reference feature quantities in the sensation category “naturalness” along the time axis to determine which part of the subject speech is unnatural. Note that this method is a method with which correlation analysis can be easily performed, but the method used by the comparator 122 is not limited to this example and any method capable of performing comparison of two statistics may be used. The result of comparison of feature quantities generated by the comparator 122 is passed on to the sensation index calculator 123.

The sensation index calculator 123 calculates a sensation index of the subject speech on the basis of the comparison result received from the comparator 122. The reference feature quantities are classified into the sensation categories on the basis of the reference sensation indices of the reference speeches as described above, and represent the features of the sensation categories. Thus, a comparison result of comparison of the feature quantities of the subject speech in a certain sensation category with the reference feature quantities in the sensation category indicates the degree to which the subject speech gives the sensation corresponding to the sensation category. The sensation index calculator 123 uses the comparison result from the comparator 122 generated for each of the sensation categories to be evaluated for the subject speech to calculate the sensation index having the sensation category to be evaluated as an element.

The sensation index of the subject speech calculated by the sensation index calculator 123 is sent to the display 140. The display 140 can display the sensation index of the subject speech in a manner clear for the user by using graphical image representation such as graphs and figures. The display 140 can also process an image on the basis of the sensation index of the subject speech and display the processed image. The display 140 may display the waveform of the subject speech, the waveform of the reference speech on which the reference feature quantities used for calculation of the sensation index are based, the reference sensation index, and the like together with the sensation index of the subject speech.

Here, an example of the method for calculating the reference sensation index calculated from a reference speech will be described. The reference sensation index is an index expressing a human sensation received from a reference speech, and is calculated in advance. The method for calculating the reference sensation index may use functional magnetic resonance imaging (fMRI), magnetoencephalogram (MEG), optical topography (near infra-red spectroscopy: NIRS, functional NIRS (fNIRS)), electroencephalogram (EEG), electro-dermal activity (EDA), a semantic differential (SD), a multidimensional scaling (MDS), or the like, and preferably use one or a combination of methods capable of evaluating human sensations including those of potential levels quantitatively and qualitatively by a technique based on neuroscience, psychology, and physiology.

In the present embodiment, brain activities of humans received from the reference speeches are analyzed by using the SD method and the fMRI based on subjective evaluation, and the reference sensation index is calculated from correlation with typical brain activities relating to “naturalness,” “enchantment,” “approach,” “avoidance,” “anger,” “sadness,” “relaxation,” “concentration,” “emergence (inspiration),” and “beauty.” The reference feature quantities described above calculated from the reference speeches are then classified into the respective sensation categories on the basis of the calculated reference sensation index. The categorization into the sensation categories may be carried out through machine learning by using a technique such as Deep Learning or may be carried out by the user.

As a result of categorizing the reference feature quantities on the basis of the reference sensation index calculated from the reference speeches in this manner, the reference feature quantities can be quantitatively classified into the sensation categories corresponding to the sensations that humans receive from speech such as “naturalness,” “enchantment,” “approach,” “avoidance,” “anger,” “sadness,” “relaxation,” “concentration,” “emergence (inspiration),” and “beauty.” Alternatively, user's preferred speech signals may be used as reference speeches. In this case, since the preferred speech signals can be categorized into sensation categories, such processing as comparing the subject speech to a preferred speech can be performed.

In the present embodiment, after frequency analysis and pseudo frequency analysis are performed on speech data, frequency band analysis using a MFCC or the like, pitch analysis, prosody analysis, or the like is performed, for example. A feature vector is then obtained through a process of generating a reference vector from the analysis result. As a result, a sensation index expressed by using a ten-dimensional vector, for example, is calculated.

Note that the frequency analysis used here may be an index of series expansion using Fourier transform, for example, and an index obtained by fractal analysis as frequency analysis can be used at the same time. Specifically, a reference for feature quantity calculation for vector generation may be extracted from different mathematical techniques or different analysis results, and a vector may be selected from a feature quantity space by an analysis process appropriate for evaluation. Although a ten-dimensional vector is used in the present embodiment, any vector having an analysis result necessary for evaluation as an element may be selected in the processing performed by the analyzer.

Furthermore, for the reference feature quantities of the respective sensation categories, reference feature quantities calculated from the respective reference speeches included in the respective sensation categories may be stored independently, or one new reference feature quantity may be generated by calculating a weighted sum of multiple reference feature quantities. In this case, it is effective to perform dimensional compression using SIFT.

Alternatively, after extracting partial feature quantities, analysis of whether or not the partial feature quantities are common can be applied to the reference speeches, and when a speech having similar partial quantities is present, a pseudo reference speech newly extracted by PCA, ICA, or the like can be generated. Similarly, a new reference speech can be generated by using a result of learning a user's preferred speech signal.

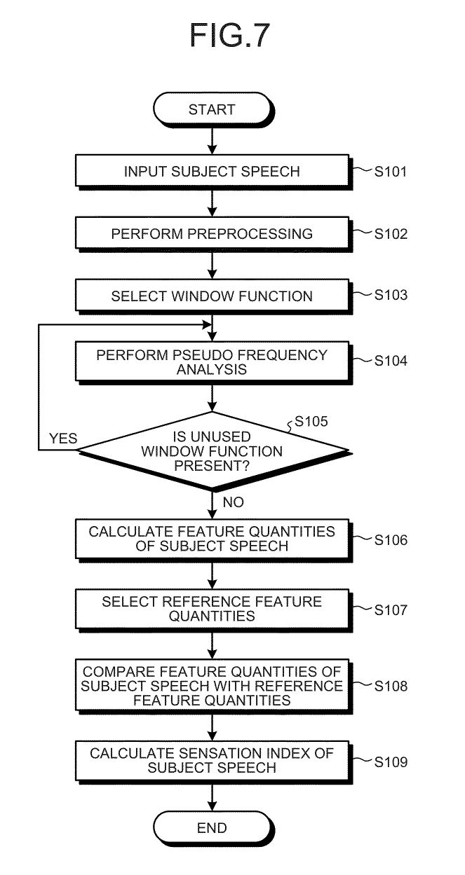

Next, operation of the speech processing device 100 according to the first embodiment will be described with reference to FIG. 7. FIG. 7 is a flowchart illustrating an outline of the operation of the speech processing device 100 according to the first embodiment.

When speech data of subject speech is input to the speech processing device 100 (step S101), the preprocessing unit 111 first performs preprocessing such as filtering for noise elimination and conversion of the sampling rate on the input speech data (step S102).

Subsequently, the window function selector 112 selects window functions according to a user's selecting operation, for example (step S103). In this process, a pair of window functions (a first window function and a second window function) is selected for at least one sensation category.

Subsequently, the analyzer 113 performs pseudo frequency analysis using the window functions selected in step S103 (step S104). The pseudo frequency analysis in step S104 is repeated the number of times corresponding to the number of window functions selected in step S103. Specifically, after the pseudo frequency analysis is terminated in step S104, it is determined whether an unused window function is present (step S105), and if an unused window function is present (step S105: Yes), the process returns to step S104, where the pseudo frequency analysis using the window function is performed.

After the pseudo frequency analysis is then performed using all of the window functions (step S105: No), the feature quantity calculator 114 calculates feature quantities of the subject speech from correlation between the result of the pseudo frequency analysis using the first window function and the result of the pseudo frequency analysis using the second window function for each of the sensation categories of the window functions used in the pseudo frequency analyses (step S106).

Subsequently, the feature quantity selector 121 selects reference feature quantities classified into the sensation categories of the window functions used in the pseudo frequency analyses (step S107). The comparator 122 then performs a process of comparing the feature quantities of the subject speech calculated in step S106 by the comparator 122 with the reference feature quantities selected in step S107 (step S108), and generates a comparison result for each of the sensation categories. The sensation index calculator 123 then calculates the sensation index of the subject speech on the basis of the comparison results (step S109). The thus calculated sensation index of the subject speech is displayed using a graphical image representation, for example, on the display 140.

As described above with specific examples, the speech processing device 100 according to the present embodiment calculates feature quantities that are obtained from correlation of analysis results of multiple pseudo frequency analyses each using different window functions on subject speech, that is, in particular, feature quantities of the subject speech from correlation between the result of pseudo frequency analysis using a first window function and the analysis result of pseudo frequency analysis using a second window function obtained by inverting the first window function in the direction of the time axis. The feature quantities of the subject speech are then compared with the reference feature quantities that are feature quantities of reference speeches for which a reference sensation index is known in advance, and the sensation index of the subject speech is calculated on the basis of the comparison result. According to the speech processing device 100 according to the present embodiment, subject speech that is a continuous sound can therefore be evaluated by using the feature quantities that cannot be acquired according to the related art, and it is possible to appropriately evaluate what influence the subject speech has on human sensations.

### Second Embodiment

Next, an example to which the speech processing device 100 according to the first embodiment is applied, in which a synthetic speech having a sensation index close to the reference sensation index of a target reference speech is generated will be described as a second embodiment.

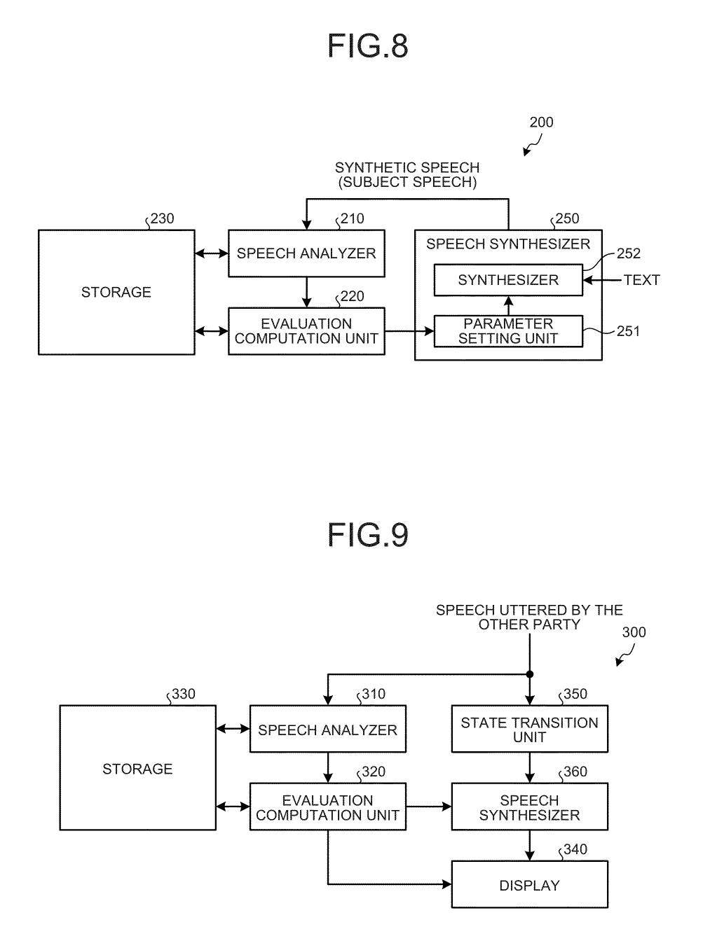

FIG. 8 is a block diagram illustrating an example configuration of a speech processing device 200 according to the second embodiment. As illustrated in FIG. 8, the speech processing device 200 includes a speech analyzer 210, an evaluation computation unit 220, a storage 230 and a speech synthesizer 250. Since the speech analyzer 210, the evaluation computation unit 220, and the storage 230 are similar to the speech analyzer 110, the evaluation computation unit 120, and the storage 130 of the first embodiment described above, detailed description of these components will not be repeated.

In the speech processing device 200 according to the present embodiment, synthetic speech generated by the speech synthesizer 250 is input as subject speech to the speech analyzer 210. The speech analyzer 210 performs the same processing as that of the speech analyzer 110 in the first embodiment on the synthetic speech input as the subject speech to calculate the feature quantities of the synthetic speech. The evaluation computation unit 220 performs the same processing as that of the evaluation computation unit 120 in the first embodiment by using the feature quantities of the synthetic speech calculated in the processing by the speech analyzer 210 to calculate a sensation index of the synthetic speech. The sensation index of the synthetic speech calculated by the evaluation computation unit 220 is passed on to the speech synthesizer 250.

The speech synthesizer 250 includes a parameter setting unit 251 and a synthesizer 252. The parameter setting unit 251 sets various parameters relating to speech synthesis such as a parameter for generating a sound source waveform or a parameter for generating a prosody. The synthesizer 252 generates synthetic speech from a text according to the parameters set by the parameter setting unit 251

Note that, in the speech processing device 200 of the present embodiment, the speech synthesizer 250 receives the sensation index of the synthetic speech generated by the synthesizer 252 from the evaluation computation unit 220, and changes the parameters set by the parameter setting unit 251 so that the sensation index of the synthetic speech becomes closer to the reference sensation index of the target reference speech. Specifically, the sensation index of the synthetic speech calculated by the evaluation computation unit 220 is compared with the reference sensation index of a reference speech specified as a target in advance. The parameter setting unit 251 sets a new parameter according to a parameter gradient toward the direction in which the difference between the sensation indices becomes smaller. The synthesizer 252 then generates synthetic speech according to the parameter newly set by the parameter setting unit 251. The synthetic speech is input as subject speech to the speech analyzer 210, and the sensation index of the synthetic speech is recalculated. The aforementioned processing is repeated until the similarity of the sensation index of the synthetic speech and the reference sensation index of the target reference speech becomes equal to or higher than a threshold, so that synthetic speech close to the reference sensation index of the target reference speech can be generated. In this process, similarly to the first embodiment, the sensation index of the synthetic speech calculated by the evaluation computation unit 220 may be displayed on a display, which is not illustrated.

As described above, according to the speech processing device 200 of the present embodiment, the synthetic speech close to the reference sensation index of the target reference speech can be generated while appropriately evaluating the influence the synthetic speech generated by the speech synthesizer 250 has on human sensations.

### Third Embodiment

Next, an example to which the speech processing device 100 according to the first embodiment is applied, in which a feeling of the other party in a dialog process is guessed will be described as a third embodiment.

FIG. 9 is a block diagram illustrating an example configuration of a speech processing device 300 according to the third embodiment. As illustrated in FIG. 9, the speech processing device 300 includes a speech analyzer 310, an evaluation computation unit 320, a storage 330, a display 340, a state transition unit 350, and a speech synthesizer 360. Since the speech analyzer 310, the evaluation computation unit 320, and the storage 330 are similar to the speech analyzer 110, the evaluation computation unit 120, and the storage 130 of the first embodiment described above, detailed description of these components will not be repeated.

The speech processing device 300 according to the present embodiment performs a dialog process with the other party of dialog by acquiring speech uttered by the other party of dialog through a telephone line and responding with synthetic speech, for example.

The speech uttered by the other party of dialog is input to the state transition unit 350. The state transition unit 350 analyzes the speech uttered by the other party of dialog to recognize the content of the utterance, and instructs the speech synthesizer 360 to respond to the speech uttered by the other party of dialog according to a state transition learned in advance. The speech synthesizer 360 generates a response with synthetic speech according to the instruction from the state transition unit 350. The response with synthetic speech generated by the speech synthesizer 360 is transferred to the other party of dialog via the display 340.

The response to dialog according to state transition with the other party of dialog is carried out by conveying the response with the synthetic speech generated by the speech synthesizer 360 as necessary to the other party of dialog while displaying an image of a half length or full length of a person on the display 340, for example. Note that the image of the person displayed on the display 340 may be a photographed image or may be computer graphics (CG).

In a case of a response to dialog at a call center, for example, the other party of dialog often has the dialog expecting a certain response. In this case, the response with synthetic speech made by the speech processing device 300 may not be sufficient for finely-tuned response to the other party of dialog. Thus, in the speech processing device 300 according to the present embodiment, while response to dialog is conducted to the other party of dialog, speech uttered by the other party of dialog is input as subject speech to the speech analyzer 310 and a sensation index of the speech uttered by the other party of dialog is calculated by the evaluation computation unit 320. If signals indicating deviation from neutral dialog, such as anger, avoidance, or the like, start to be observed as a result of evaluation of the calculated sensation index, the first signal is displayed on the display 340, for example, and the actual condition of dialog is highlighted. Thereafter, if a strong signal indicating that the sensation index of the speech uttered by the other party of dialog is further deviated from neutral dialog is observed, the same is conveyed to the operator by display of warning on the display 340 or the like. The operator switches the dialog response to which a warning is given by the system to a response made by the operator himself/herself at a good timing.

As described above, according to the speech processing device 300 of the present embodiment, since deviation from neutral dialog is determined by using the sensation index of speech uttered by the other party of dialog and a warning is given where necessary, it is possible to appropriately switch between response to dialog with synthetic speech and response from the operator himself/herself depending on the condition of the dialog and achieve both efficient response to dialog with synthetic speech and finely-tuned response to the other party of dialog.

Supplementary Explanation

The speech processing devices according to the embodiments described above may be constituted by server-client systems, for example. In this case, a server device receives subject speech and reference speeches from a client device, calculates a sensation index of the subject speech and returns the calculated sensation index to the client device. The client device can perform various processes such as information display based on the sensation index of the subject speech calculated by the server device. In this case, the server device may collect area information in which the client device is used by using a global positioning system (GPS) or the like. As a result of using the area information in which the client device is used, it is possible to conduct appropriate evaluation on subject speech containing expressions and dialects peculiar to the area by using similar reference speeches.

The speech processing device according to each of the embodiments described above can be constituted by a general-purpose computer system used as basic hardware. Specifically, functional components of the speech processing device of each of the embodiments described above can be implemented by executing predetermined programs while using a memory by a processor mounted on the general-purpose computer system. The speech processing device may be realized by installing the programs in the computer system in advance, or may be realized by storing the programs in a storage medium such as a CD-ROM or distributing the programs via a network and installing the programs in the computer system where necessary. Alternatively, the speech processing device may be achieved by executing the programs on a server computer system and receiving the result by a client computer system via a network.

Furthermore, information to be used by the speech processing devices according to the embodiments described above can be stored using a memory included in the computer system or an external memory, a hard disk or a recording medium such as a CD-R, a CD-RW, a DVD-RAM, and a DVD-R as appropriate. For example, window functions, reference feature quantities, reference speeches, reference sensation indices, and the like used by the speech processing devices according to the embodiments described above can be stored using these storage media as appropriate.

Programs to be executed by the speech processing devices according to the embodiments described above have a modular structure including the respective processing units (functional components) included in the speech processing devices. In an actual hardware configuration, a processor reads the programs from the storage media and executes the programs, whereby the respective processing units are loaded on a main memory and generated thereon, for example.

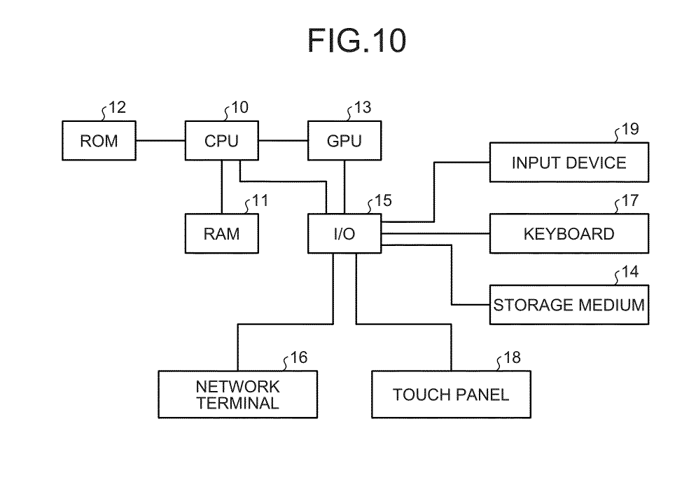

Here, a specific example of a hardware configuration of a speech processing device will be described with reference to FIG. 10. FIG. 10 is a block diagram illustrating an example hardware configuration of the speech processing device 300 according to the third embodiment described above. The speech processing device 300 having the hardware configuration illustrated in FIG. 10 is started according to a system start-up information stored in a ROM 12. Major inputs to the speech processing device 300 are video and speech signals, which are input into the device by an input device 19. For supplementing input or for processing display of a wide range of information and input at the same time, a touch panel 18 constituting the display 340 is provided. A keyboard 17 for correcting errors of choices in a screen and speech input by the user may be provided for input.

Various signals input to the speech processing device 300 pass through an I/O 15, are processed by the speech analyzer 310 and the evaluation computation unit 320 implemented by a CPU 10 and a RAM 11, and are processed by the state transition unit 350 and the speech synthesizer 360 implemented by the CPU 10 and the RAM 11. The storage 330 is constituted by a storage medium 14. In the hardware configuration of the present example, the response time can be shortened and energy can be saved by executing part of processing of the speech analyzer 310 and part of processing of the evaluation computation unit 320 by using a GPU 13. A network terminal 16 is provided for input from and output to the outside of the device, and used for processing in a distributed environment or a cloud in which various processes are performed via a network, updating systems, and the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A speech processing device comprising:
an analyzer to perform multiple pseudo frequency analyses each using different window functions on subject speech to be processed;
a feature quantity calculator to calculate a feature quantity of the subject speech on the basis of analysis results of the multiple pseudo frequency analyses;
a comparator to compare the feature quantity of the subject speech with a reference feature quantity calculated from reference speech and generate a comparison result; and
a sensation index calculator to calculate a sensation index representing a sensation received from the subject speech on the basis of the comparison result.

2. The device according to claim 1, wherein the analyzer performs at least pseudo frequency analysis using a first window function that is an asymmetric window function along a time axis and pseudo frequency analysis using a second window function that is a window function obtained by inverting the first window function in a direction of the time axis.

3. The device according to claim 2, further comprising a storage to store therein, for each predetermined sensation category, a pair of window functions consisting of the first window function and the second window function and the reference feature quantity, wherein
the analyzer performs multiple pseudo frequency analyses each using a pair of window functions selected from the storage depending on a sensation category to be evaluated,
the comparator compares the feature quantity of the subject speech with the reference feature quantity associated with the sensation category to be evaluated and generates a comparison result, and
the sensation index calculator calculates the sensation index containing, as elements thereof, sensation categories to be evaluated on the basis of the comparison result.

4. The device according to claim 1, wherein the reference feature quantity is a feature quantity calculated by the feature quantity calculator on the basis of results of performing multiple pseudo frequency analyses each using different window functions on the reference speech by the analyzer.

5. The device according to claim 1, wherein the reference speech includes natural speech uttered with emotion by a human.

6. The device according to claim 1, further comprising a speech synthesizer to generate synthetic speech according to a predetermined speech synthesis parameter, wherein
the subject speech is synthetic speech generated by the speech synthesizer, and
the speech synthesizer changes the speech synthesis parameter so that the sensation index of the synthetic speech calculated by the sensation index calculator becomes closer to a target sensation index.

7. The device according to claim 1, further comprising a display to display information on the basis of the sensation index calculated by the sensation index calculator.

8. The device according to claim 1, wherein the analyzer performs wavelet analyses as the pseudo frequency analyses.

9. A speech processing method performed in a speech processing device, the method comprising:
performing multiple pseudo frequency analyses each using different window functions on subject speech to be processed;
calculating a feature quantity of the subject speech on the basis of analysis results of the multiple pseudo frequency analyses;
comparing the feature quantity of the subject speech with a reference feature quantity generated from reference speech and generating a comparison result; and
calculating a sensation index representing a sensation received from the subject speech on the basis of the comparison result.

10. A computer program product comprising a computer-readable medium including programmed instructions, the instructions causing a computer to have:
a function of performing multiple pseudo frequency analyses each using different window functions on subject speech to be processed;
a function of calculating a feature quantity of the subject speech on the basis of analysis results of the multiple pseudo frequency analyses;
a function of comparing the feature quantity of the subject speech with a reference feature quantity generated from reference speech and generating a comparison result; and
a function of calculating a sensation index representing a sensation received from the subject speech on the basis of the comparison result.
